(19) United States
(12) Patent Application Publication
(10) Pub. No.: US 2016/0314569 A1
(43) Pub. Date: Oct. 27, 2016

(54) METHOD TO SELECT BEST KEYFRAMES IN ONLINE AND OFFLINE MODE

(71) Applicant: Ilya Lysenkov, Nizhny Novgorod (RU)

(72) Inventor: Ilya Lysenkov, Nizhny Novgorod (RU)

(21) Appl. No.: 15/097,121

(22) Filed: Apr. 12, 2016

Related U.S. Application Data
(60) Provisional application No. 62/151,520, filed on Apr. 23, 2015.

(51) Int. Cl. G06T 7/00; G06K 9/62

(52) U.S. Cl. CPC G06T 7/0002; G06K 9/6215; G06K 9/6219; G06T 2207/10016; G06T 2207/30168; G06T 2207/20081

(57) ABSTRACT

The present invention provides a method for 3D scanning of an object comprising selecting a keyframe from a set of frames for subsequent processing.

### CROSS REFERENCE TO RELATED APPLICATIONS

This application claims the benefit of U.S. Provisional Application No. 62/151,520, filed Apr. 23, 2015, the entire content of which is incorporated by reference.

### BACKGROUND OF THE INVENTION

1. Field of Invention

The present invention relates to an efficient three dimensional scanning of an object with reduced computation time, memory requirements, disc storage and network bandwidth usage requirements.

2. Summary of the Invention

The new algorithm aims to select best keyframes from a set of frames (e.g. a video stream) for subsequent processing with the main application in 3D scanning. The proposed scheme works both in online mode (when frames are captured one-by-one and keyframe selection is accomplished on-the-fly) and in offline mode (when all frames are already captured). The proposed algorithm simultaneously fulfills several criteria: the online process should be intuitive for the user and convey his/her intent, the scanned entity (object, person, room, etc.) should be covered from all view angles, the selected images should have the highest level of details to allow texture of the best quality.

All available raw frames for a scan contain redundant information so it is possible to select only several keyframes to achieve reduction in computation time, memory requirements, disk storage and network bandwidth usage. The problem is that in using a naïve approach (e.g. just selecting every 10th frame) the result is a degradation of the quality of a 3D model because such an approach can drop occasionally a high-quality frame and keep a blurred frame. So the goal of the present invention is to develop an algorithm of keyframe selection than can bring the advantages but without harming the final result and user experience.

Two algorithms were developed for selection of keyframes: the first is for online mode, and the second one is for offline mode.

### DETAILED DESCRIPTION OF THE PRESENTLY PREFERRED EMBODIMENTS

Online mode:
   1. For each timeframe of the scanning session (e.g. for each second in the scanning session):

1.1. For each new frame in the timeframe:
1.1.1. resize original high-resolution image (e.g. FHD) to low-resolution one (e.g. VGA)
1.1.2. if available extract the intensity channel (e.g. Y for YUV format) otherwise convert image to grayscale (e.g. for RGB format)
1.1.3. compute Laplacian (Marr, 1982) for each pixel in the image
1.1.4. compute mean absolute value of Laplacian; this serves as indication of quality of the image: it will be low for blurry images and high for sharp images
1.1.5. if the quality is better than in previous frames remember the current frame and its quality as the best one

1.2. use the best frame in the timeframe as the keyframe (e.g. remember it in memory, write to a disk, send to cloud, etc.)
Offline mode:
   For each pair of frames compute their similarity in terms of scanned entity coverage. It is achieved by computing Intersection-over-Union metric (Jaccard index, Jaccard, 1912) for point clouds of two frames. We introduce its efficient variant for point clouds by computing it using voxel grids and counting intersection and union between these two voxel grids.
   2. Run agglomerative hierarchical clustering with complete linkage (Lance & Williams, 1967) until the number of clusters is equal to desired number of keyframes.
   3. For each cluster of frames find the frame with the best image quality. The image quality is calculated as sum of squared gradients computed with Sobel operator. The gradients are summed only over the region, which corresponds to the object excluding background. So the image quality will be high when an object is sharp and occupies a big part of the image i.e. captured from a close distance.
   4. The selected keyframes are the best frames in each cluster.

Online keyframe selection is commonly achieved by adding a new keyframe when a user moves too far from the position of a previous keyframe (measured e.g. by geometric distances or by decreased stability of tracking) and without taking into account quality of this keyframe. However, the situation when a user departs too far from a previous position is usually caused by fast camera movements and so the selected keyframe can be blurry. The presently disclosed online keyframe selection algorithm finds the accidental pauses in the continuous motion of a camera and takes a keyframe at exactly this point and so get significantly less blurry frames. Also it better conveys the intent of a user and gives him/her intuitive behavior. For example, if a user wants to scan a part with high level of details and scans this part thoroughly, the proposed method will select more keyframes for this part than for other regions that a user did not spend much time on. Offline selection takes into account all available data and produces keyframe suitable both for meshing and texturing. Usual strategies for offline keyframe selection in 3D reconstruction aim to select keyframes only for reliable determination of camera poses, their internal parameters and locations of features but ignore requirements of subsequent essential tasks: meshing and texturing. The present strategy resolves this problem and allows us to obtain triangulated and textured 3D models of high quality. Also a novel efficient way is introduced to compute similarity between two point clouds, which reflects coverage of a scanned entity by these two clouds.

The invention is not limited by the embodiments described above which are presented as examples only but can be modified in various ways within the scope of protection defined by the appended patent claims.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

### REFERENCES

Jaccard, Paul (1912), “The distribution of the flora in the alpine zone”, New Phytologist 11: 37-50.

Lance, G. N., & Williams, W. T. (1967). A general theory of classificatory sorting strategies 1. Hierarchical systems. The computer journal, 9(4), 373-380.

D. Marr (1982). Vision. San Francisco: Freeman

### Other Relevant References

Ahmed, M. T., Dailey, M. N., Landabaso, J. L., & Herrero, N. (2010, May). Robust Key Frame Extraction for 3D Reconstruction from Video Streams. In VISAPP (1) (pp. 231-236).

Rashidi, A., Dai, F., Brilakis, I., & Vela, P. (2013). Optimized selection of key frames for monocular videogrammetric surveying of civil infrastructure. Advanced Engineering Informatics, 27(2), 270-282.

Park, M. G., & Yoon, K. J. (2011). Optimal key-frame selection for video-based structure-from-motion. Electronics letters, 47(25), 1367-1369.

Knoblauch, D., Hess-Flores, M., Duchaineau, M. A., Joy, K. I., & Kuester, F. (2011). Non-parametric sequential frame decimation for scene reconstruction in low-memory streaming environments. In Advances in Visual Computing (pp. 359-370). Springer Berlin Heidelberg.

Dong, Z., Zhang, G., Jia, J., & Bao, H. (2009, September). Keyframe-based real-time camera tracking. In Computer Vision, 2009 IEEE 12th International Conference on (pp. 1538-1545). IEEE.

1. A method for 3D scanning of an object comprising selecting a keyframe from a set of frames for subsequent processing, wherein for each frame in the set of frames:
a) resize original high-resolution image to low-resolution image;
b) optionally extract the intensity channel and convert image to grayscale;
c) compute Laplacian for each pixel in the image;
d) compute mean absolute value of Laplacian;
e) determine if the quality of the image is better than in previous frames; and
f) select the frame having the best quality image as the keyframe.

2. A method for 3D scanning of an object comprising the step of selecting a keyframe from a set of frames for subsequent processing, wherein the step comprises:
a) computing similarity of the scanned entity coverage between two frames;
b) running agglomerative hierarchical clustering with complete linkage until the number of clusters is equal to desired number of keyframes; and
c) finding the frame with the best image quality for each cluster of frames so as to select the keyframe for each cluster of frames.
